(19) United States
(12) Patent Application Publication
(10) Pub. No.: US 2005/0018786 A1
(43) Pub. Date: Jan. 27, 2005

(54) Interleaved trellis coded modulation and decoding

(76) Inventors: Keshab K. Parhi, Maple Grove, MN (US); Yongru Gu, St. Paul, MN (US)

Correspondence Address: Keshab K. Parhi, 6600 Fountain Lane N., Maple Grove, MN, 55311, US

(21) Appl. No.: 10/897,893

(22) Filed: Jul. 21, 2004

Related U.S. Application Data
(60) Provisional application No. 60/488,874, filed on Jul. 21, 2003.

(51) Int. Cl. H04L 5/12

(52) U.S. Cl. 375/265

(57) ABSTRACT

Digital communications systems employ trellis coded modulation schemes. A K-dimensional trellis coded modulated symbol is transmitted over M channels in K/M cycles (where M divides K). K/M consecutive data units are transmitted serially in a time multiplexed manner in K/M consecutive cycles over one channel. If M=1, then each symbol is transmitted over one channel in K cycles in a time-multiplexed manner. At the receiver, a symbol is formed by grouping the data received from M channels in K/M cycles and this symbol is then decoded by a joint equalizer and decoder. If the number of parallel channels is N, then N/M trellis coded modulators and N/M decoders can be used in parallel. The advantage of this approach is an increase in speed by factor N/M. The N/M trellis coded modulation and joint equalization and decoding operations can also be implemented by using fewer hardware trellis coded modulators and decoders using folding technique where multiple operations are time-multiplexed to the same hardware modulator or decoder which are operated by higher clock speed.

### CROSS-REFERENCE TO RELATED APPLICATIONS

This application claims the benefit of U.S. Provisional Application No. 60/488,874, filed on Jul. 21, 2004, which is incorporated herein by reference in its entirety.

### FIELD OF THE INVENTION

The present invention relates to data transmission. More particularly, it relates to the way we use trellis coded modulation for data transmission.

### BACKGROUND OF THE INVENTION

Trellis coded modulation has been widely used in many communication systems, such as 1000BASE-T (Gigabit Ethernet over copper), which uses a 4 dimensional (4D) 8-state trellis code combined with 5-level pulse amplitude modulation. Usually, these systems suffer inter-symbol interference. One approach to decode the trellis coded signals is called (MLSE) maximum likelihood sequence estimation. However, it requires the use of a Viterbi decoder with a large number of states, as a result of the combination of trellis coding with the inter-symbol interference channel. Another approach is called DFSE (decision feedback sequence estimation) where it only requires the use of a Viterbi decoder with the same number of states as the trellis encoder. Intersymbol interference is removed by feedbacking the tentative decisions associated with each survivor path in the Viterbi decoder. This creates a timing problem (or so-called critical path problem), especially in high speed communication systems. It requires the corresponding decoder with a long critical path to finish all its computations in a very short time. For example, in 1000BASE-T, the implementation of the DFSE algorithm with a critical path consisting of a Viterbi decoder and a decision-feedback unit needs to operate at 125 MHz. It is quite challenging to implement such a decoder.

One common approach to solve the critical path is to develop high speed decoders. In this invention, an alternate approach is considered where the encoding and modulation scheme is changed such that the inherent decoding speed requirement for the decoder can be relaxed.

### BRIEF SUMMARY OF THE INVENTION

The present invention provides a new way to use trellis coded modulation for high speed communication systems with multiple parallel channels. A typical example of such systems is 1000BASE-T, where data communication is performed simultaneously over four pairs of copper cables. Consider a communication system of higher throughput which uses 4 dimensional trellis coded modulation over four pairs of channels, traditional trellis coded modulation scheme as in 1000BASE-T leads to a design where the corresponding decoder with a long critical path needs to operate at higher speed than in 1000BASE-T. It is difficult to meet the critical path requirements of such a decoder. To solve the problem, two interleaved trellis coded modulation schemes are proposed. The inherent decoding speed requirements are relaxed by factors of 4 and 2, respectively. Parallel decoding of the interleaved codes requires multiple decoders. To reduce the hardware overhead, time-multiplexed or folded decoder structures are pro—posed where only one decoder is needed and each delay in the decoder is replaced with four delays for scheme I and two delays for scheme II, respectively. These delays can be used to reduce the critical path. Compared with the conventional decoder, the folded decoders for the two proposed schemes can achieve speedups of 4 and 2, respectively.

The idea of interleaved trellis coded modulation and decoding can be used for a wide variety of real-world applications which use trellis coded modulation and multiple channels, such as high speed Ethernet systems.

### BRIEF DESCRIPTION OF THE DRAWINGS/FIGURES

The present invention is described with reference to the accompanying figures. In the figures, like reference numbers indicate identical or functionally similar elements. Additionally, the left-most digit or digits of a reference number identify the figure in which the reference number first appears. The accompanying figures, which are incorporated herein and form part of the specification, illustrate the present invention and, together with the description, further serve to explain the principles of the invention and to enable a person skilled in the relevant art to make and use the invention.

FIG. 1 illustrates the traditional encoding scheme.

FIG. 2 illustrates the decoding scheme for the traditional encoding scheme.

FIG. 3 illustrates the proposed trellis encoding scheme I.

FIG. 4 illustrated the parallel decoding scheme for the proposed scheme I.

FIG. 5 illustrates the proposed trellis encoding scheme II.

FIG. 6 illustrates the parallel decoding scheme for the proposed scheme II.

FIG. 7 illustrated the case where there are 8 channels and each channel has its own trellis encoder.

FIG. 8 illustrates the case where there are 8 channels and each two channels share a trellis encoder.

FIG. 9 illustrates the case where there are 8 channels and each four channels share a trellis encoder.

### DETAILED DESCRIPTION OF THE INVENTION

Background on Conventional Trellis Coded Modulation and Decoding

To explain the principles of the invention better, we assume there is a communication system which uses trellis coded modulation and four pair of wires, just like in 1000BASE-T. We further assume the trellis code is also a 4 dimensional trellis code. But the throughput of the system is 10 Gbps, and the symbol rate is 833 MHz with each 1D symbol representing 3 bits of information.

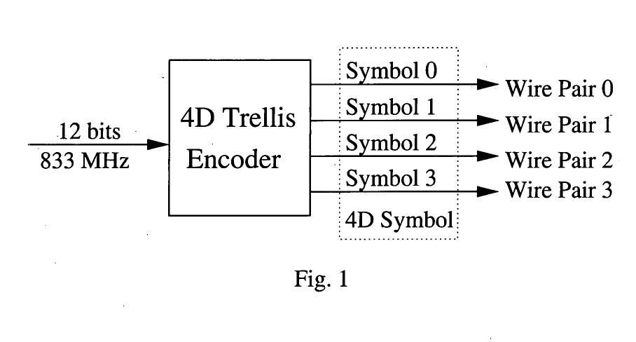

The trellis coded modulation can be used in a traditional way as in 1000BASE-T, where four wire pairs share a trellis encoder, as illustrated in FIG. 1. Each time, the encoder takes 12 bits of information and converts them to a 4D symbol at a speed of 833 MHz. Each 4D symbol contains 4 1D symbols. The four 1D symbols are transmitted over the four pairs with one dimension per pair.

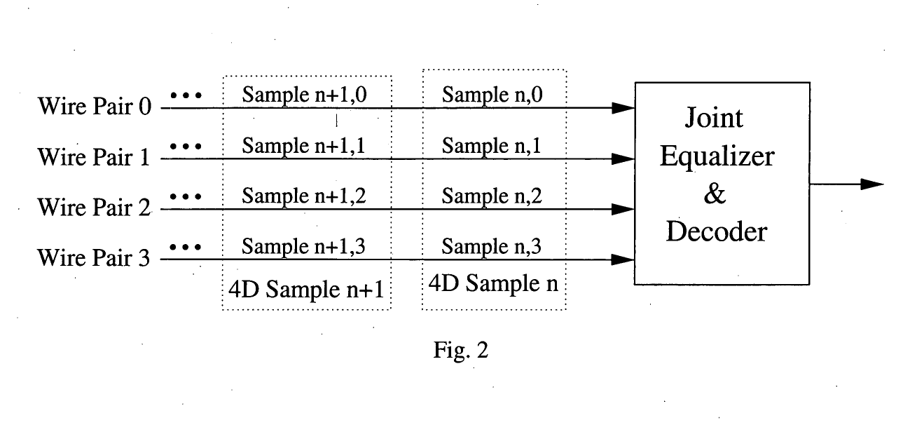

FIG. 2 shows the corresponding decoding scheme. To meet the throughput requirement, the joint equalizer and decoder (JED), which implements the DFSE algorithm, needs to operate at 833 MHz. Due to its long critical path, it is difficult for the joint equalizer and decoder to operate at 833 MHz even with the latest CMOS technology.

Interleaved Trellis Coded Modulation and Decoding Scheme I

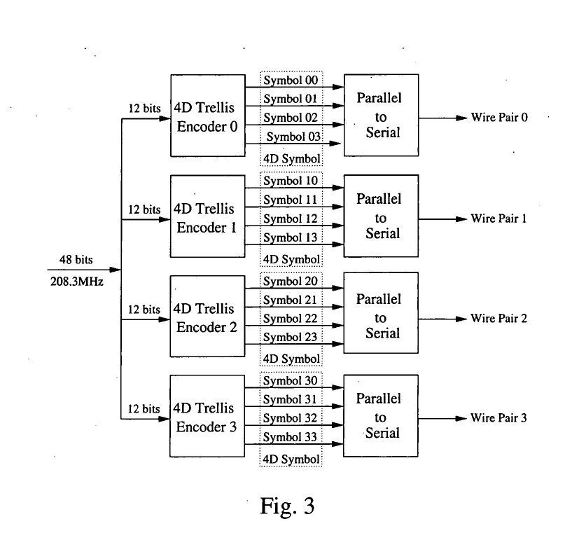

FIG. 3 shows the proposed interleaved trellis coded modulation scheme I. From the figure, we can see that each wire pair has its own encoder, and the encoding for different wire pairs is independent. In each iteration, the four encoders take 48 bit of information together with 12 bits per encoder at a speed of 208.3 MHz. Each constituent encoder is the same as the one used in the traditional encoding scheme. The resulting 4 1D symbols of each 4D symbol go through a parallel-to-serial converter and are transmitted consecutively over the same wire pair.

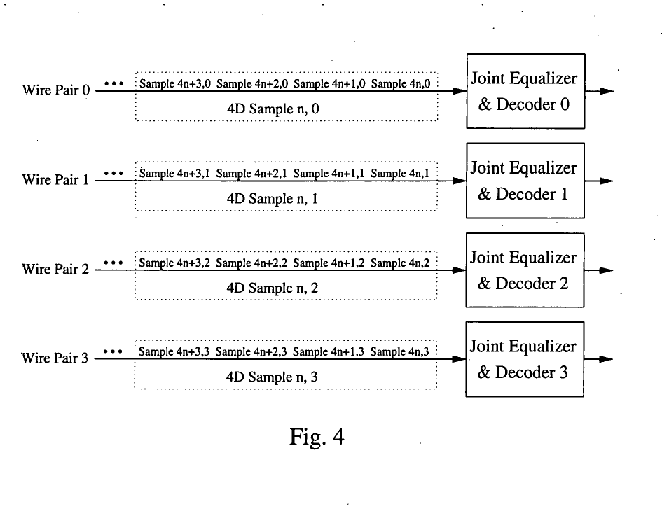

Since the encoding for each wire pair is independent, the decoding for different pairs can also be independent. Thus four parallel JEDs can be used with one JED per pair as depicted in FIG. 4. Each JED inputs 4 consecutive samples from the associated wire pair and gives an estimate of the current transmitted 4D symbol. The required decoding speed for each JED is only 208 MHz which means the critical path can be four times as long as that of the JED for traditional trellis coded modulation. The drawback of parallel decoding is the hardware overhead. Four JEDs instead of one decoder are needed now.

To reduce the hardware overhead of parallel decoding, a folded JED can be used where the computations of the four parallel JEDs are time-multiplexed to a single JED, and each delay in the JED is replaced by four delays. The silicon area comes down by a factor of 4 compared with the parallel decoding structure. The critical path can be reduced by a factor of 4 after retiming the additional delays. The clock speed can be increased by factor 4 to 833 MHz in order to maintain a throughput of 10 Gbps.

Interleaved Trellis Coded Modulation and Decoding Scheme II

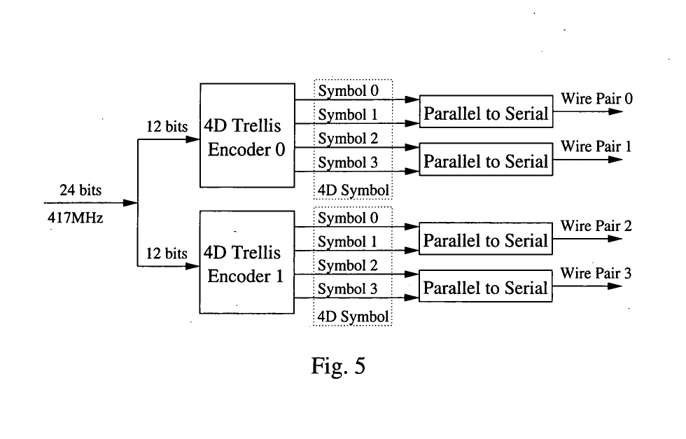

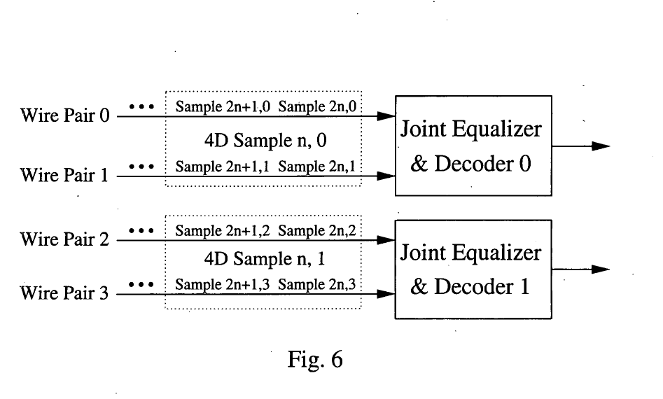

FIG. 5 shows the proposed interleaved scheme 2. It is similar to scheme I. But here two wire pairs share a 4D trellis encoder and two 4D encoders are needed. The encoding speed for each encoder is 417 MHz. The resulting 4 1D symbols of each iteration of each encoder are transmitted over the associated two wire pairs with two dimensions per pair. The parallel decoding scheme is shown in FIG. 6, where two JEDs are needed with one decoder per two pairs. The decoding speed requirement is only 417 MHz. Like in scheme I, a folded JED can be used to reduce the hardware overhead. Theoretically, the folded JED can achieve a speedup of 2 if the critical path of a JED in the parallel decoding scheme is the same as that of the JED for the traditional trellis coded modulation.

### Generalization

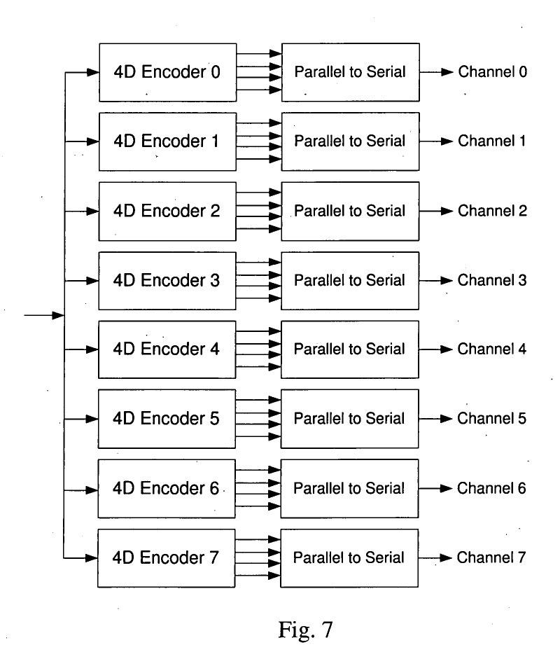

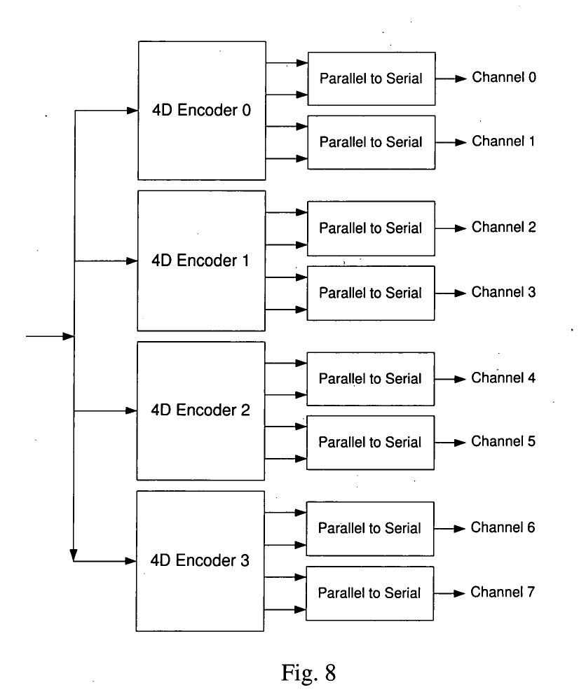

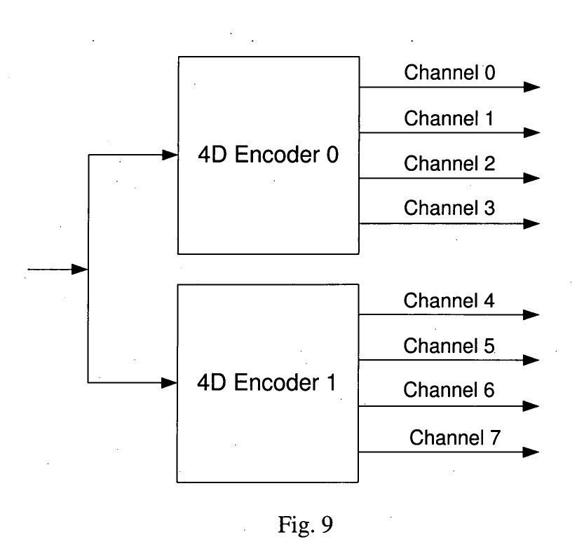

The ideas in the previous sub-sections can be generalized to cases with different dimension of trellis code and different number of parallel channels. For example, suppose we have a case where the dimension of trellis code, K, is equal to 4, and the number of parallel channels, N, is equal to 8. FIGS. 7 through 9 shows the proposed different ways to use the trellis coded modulation. In FIG. 7, we need 8 parallel encoders. The four 1-dimensional symbols of each generated 4-dimensional symbol are transmitted over the same channel. In FIG. 8, each two channels share a trellis encoder, and 4 parallel encoders are needed. In FIG. 9, each four channels share a trellis encoder, and 2 parallel encoders are needed. The four 1-dimensional symbols of each generated 4-dimensional symbol are transmitted over the associated four channels simultaneously.

### CONCLUSIONS

Various embodiments of the present invention have been described above. These embodiments can be implemented in optical, twisted-pair, coaxial cable receivers. These embodiments can be implemented in systems other than communications systems. It should be understood that these embodiments have been presented by way of example only. It will be understood by those skilled in the relevant art that various changes in form and details of the embodiments above may be made without departing from the spirit and scope of the present invention as defined in the claims.

1. A method for transmitting data using a K-dimensional trellis coded modulation over N parallel channels (N>K), the method comprising:
(a) selecting the number of channels (M) used to transmit the said K-dimensional symbol, wherein M divides both K and N and is not same as N,
(b) processing of multiple bits of a frame to generate a K-dimensional trellis coded modulated symbol and transmitting the K dimensions of the said symbol over M channels, with K/M dimensions per channel, in a time multiplexed manner in K/M cycles, and repeating this process a total of N/M times to generate data to be transmitted over all N channels, and
(c) decoding a symbol by processing the received data from groups of M channels over K/M cycles, and repeating this process a total of N/M times.

2. The method of claim 1, wherein the number of parallel channels (N) is four, and the said trellis coded modulator is a 4-dimensional modulator (K=4), and each 4-dimensional symbol is transmitted in a time multiplexed manner over one channel (M=1).

3. The method of claim 1 wherein number of parallel channels (N) is four and the trellis coded modulator a 4-dimensional modulator (K=4), and each 4-dimensional symbol is transmitted in a time multiplexed manner over two channels (M=2).

4. An integrated circuit transceiver processing data in the manner described by claim 1 with N/M encoders and N/M decoders.

5. An integrated circuit transceiver processing data in the manner described by claim 1 using less than N/M encoders and less than N/M decoders.

6. An integrated circuit transceiver processing data over parallel channels, at a rate in excess of 1 gigabit per second, comprising:
(a) at least one K-dimensional trellis coded modulator in the transmitter that processes a plurality of input values to generate a K-dimensional symbol, and these K dimensions are transmitted in the same channel in a time multiplexed manner over K cycles,
(b) at least 1 parallel-to-serial converter which processes K data units in parallel and outputs these serially in K cycles, and
(c) at least one joint equalizer and decoder in the receiver where the K dimensions received over one channel in K cycles are grouped to form one symbol which is decoded by the said joint equalizer and decoder.

7. The integrated circuit transceiver in claim 6 where the number of parallel channels is 4 and the trellis coded modulation is a 4-dimensional trellis coded modulation.

8. The integrated circuit transceiver in claim 6 containing N trellis coded modulators and N joint equalizers and decoders, where N is the number of parallel channels.

9. The integrated circuit transceiver in claim 6 containing N′ trellis coded modulators and N′ joint equalizers and detectors, where N′ divides the number of parallel channels (N).

10. The integrated circuit transceiver in claim 6 used for data transmission over copper.

11. The integrated circuit transceiver in claim 6 used for data transmission over fiber.

12. The integrated circuit transceiver in claim 6 used for data transmission over wireless.

13. An integrated circuit transceiver processing data over parallel channels, at a rate in excess of 1 gigabit per second, comprising:
(a) at least one K-dimensional trellis coded modulator in the transmitter that processes a plurality of input values to generate a K-dimensional symbol, and these K dimensions are transmitted over M channels in a time multiplexed manner in K/M cycles,
(b) at least 1 parallel-to-serial converter which processes K/M data units in parallel and outputs these serially in K/M cycles, and
(c) at least one joint equalizer and decoder in the receiver where the K dimensions received over M channels in K/M consecutive cycles are grouped to form one symbol which is decoded by the said joint equalizer and decoder.

14. The integrated circuit transceiver in claim 13 where the number of parallel channels is 4 and the trellis coded modulation is a 4-dimensional trellis coded modulation.

15. The integrated circuit transceiver in claim 13 containing N/M trellis coded modulators and N/M joint equalizers and decoders, where N is the number of parallel channels.

16. The integrated circuit transceiver in claim 13 containing N′ trellis coded modulators and N′ joint equalizers and detectors, where N′ divides N/M where N is the number of parallel channels.

17. The integrated circuit transceiver in claim 13 used for data transmission over copper.

18. The integrated circuit transceiver in claim 13 used for data transmission over fiber.

19. The integrated circuit transceiver in claim 13 used for data transmission over wireless.
